(19) United States
(12) Patent Application Publication
(10) Pub. No.: US 2011/0248920 A1
(43) Pub. Date: Oct. 13, 2011

(54) KEYBOARD WITH HINGED KEYS AND DISPLAY FUNCTIONALITY

(75) Inventor: Glen C. Larsen, Issaquah, WA (US)

(73) Assignee: MICROSOFT CORPORATION, Redmond, WA (US)

(21) Appl. No.: 12/757,732

(22) Filed: Apr. 9, 2010

(51) Int. Cl. G06F 3/02

(52) U.S. Cl. 345/168

(57) ABSTRACT

A computer peripheral is provided. The computer peripheral includes a display device and a keyboard assembly. The keyboard assembly is disposed over the display device. The keyboard assembly is configured to permit viewing of images produced by the display device through the keyboard assembly. Further, the keyboard assembly includes a base structure and a plurality of keys. Each of the plurality of keys is selectively physically depressible relative to the base structure to cause production of an input signal. Further, each of the plurality of keys is movably coupled with respect to the base structure via a hinge at one edge of the key. Further still, each of the plurality of keys includes a transparent portion to permit viewing of the images produced by the display device through the key.

### BACKGROUND

Computer peripherals are continually being refined to expand functionality and provide quality user experiences. One area of improvement has been to provide peripheral devices that combine keyboard-type input functionality with the ability to display output to the user. In many cases, this is implemented by providing a keyboard with a display region that is separate from the keys. For example, in a conventional keyboard layout, a rectangular LCD display can be situated above the function keys or number pad.

Another approach to combining input and output capability in a peripheral device is the use of a virtual keyboard on a touch interactive display. In this case, the display capability is provided directly on the keys: each key typically is displayed by the touch interactive device with a legend or symbol that indicates its function. The virtual keyboard approach has many benefits, including the ability to dynamically change the display for each key. Interactive touch displays are often less desirable, however, from a pure input standpoint. Specifically, touch displays do not provide tactile user feedback, which can provide a more responsive and agreeable typing experience.

### SUMMARY

According to one aspect of the disclosure, a computer peripheral is provided. The computer peripheral includes a display device and a keyboard assembly. The keyboard assembly is disposed over the display device. The keyboard assembly is configured to permit viewing of images produced by the display device through the keyboard assembly. Further, the keyboard assembly includes a base structure and a plurality of keys. Each of the plurality of keys is selectively physically depressible relative to the base structure to cause production of an input signal. Further, each of the plurality of keys is movably coupled with respect to the base structure via a hinge at one edge of the key. Further still, each of the plurality of keys includes a transparent portion to permit viewing of the images produced by the display device through the key.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates an exemplary computing system including a computer peripheral that provides the ability to display viewable output in connection with the keys of a keyboard assembly.

FIG. 2 is an exploded view of the computer peripheral shown in FIG. 1, and shows viewable display output being provided by a display device underlying the keyboard assembly of the computer peripheral.

FIG. 3 illustrates an example of the output display capability that may be employed in connection with the computer peripheral of FIGS. 1 and 2.

FIG. 4 is a side view of a key which illustrates viewing considerations associated with through-key viewing of images produced by a display device.

FIG. 5 illustrates an exemplary configuration for a keyboard assembly base structure having offset tactile structures to provide user feedback.

FIGS. 6-8 are side views showing exemplary embodiments of a key and related structures that may be employed in connection with the computer peripheral of FIGS. 1 and 2.

### DETAILED DESCRIPTION

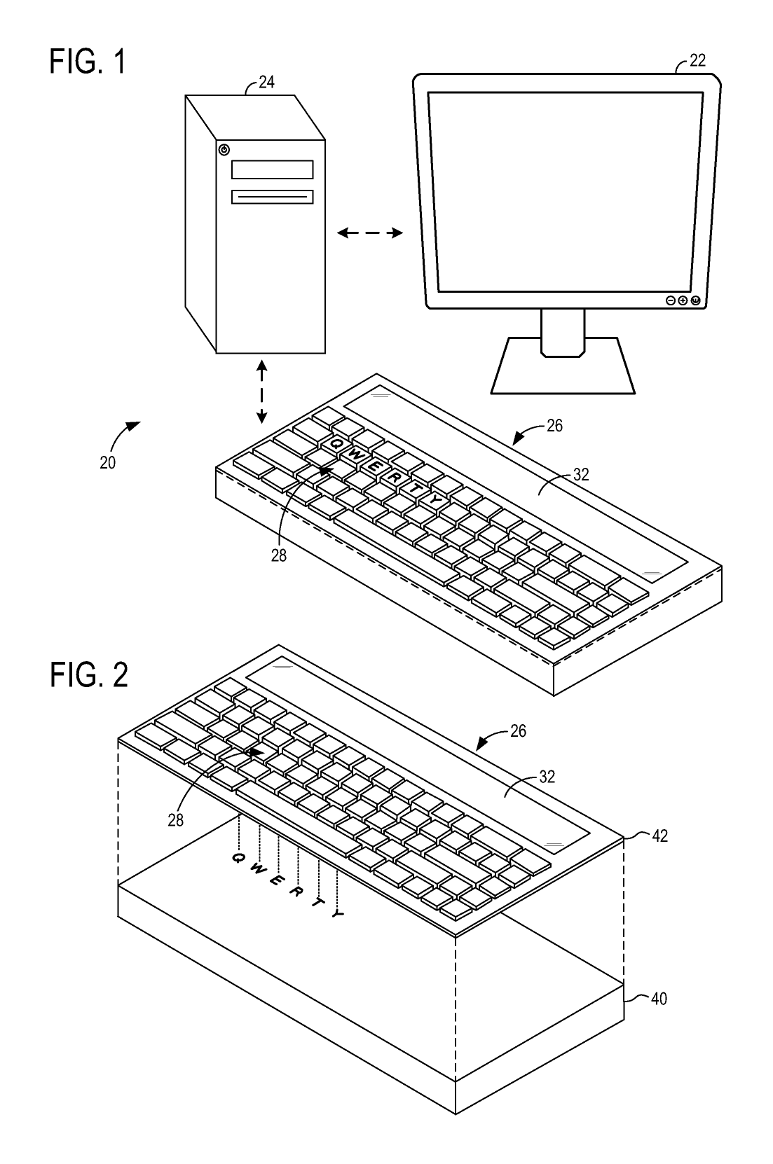

FIG. 1 depicts an exemplary computing system 20 including a display monitor 22, a component enclosure 24 (e.g., containing a processor, hard drive, etc.), and a computer peripheral 26. FIG. 2 provides an additional view of computer peripheral 26 and exemplary components that may be used in its construction. As will be described in various examples, computer peripheral 26 may be implemented to provide displayable output in addition to keyboard-type input functionality. The display functionality may be enhanced through use of a keyboard assembly having keys that are at least partially transparent and coupled to an underlying base structure via hinge structures. The transparency enables through-key viewing of images produced by a display device situated underneath the keyboard assembly. Furthermore, tactile structures, such as tactile domes, may be provided to produce tactile user feedback during key activation. The tactile structures and hinge structures may be offset from the key centers, or otherwise situated so as to maximize useable display area of the underlying display device.

The terms “input” and “output” will be used frequently in this description in reference to the keyboard functionality of the exemplary computer peripherals. When used in connection with a keyboard key, the term “input” will generally refer to the input signal that is provided by the peripheral upon activation of the key. “Output” will generally refer to the display provided for a key, such as the displayed legend, icon or symbol that indicates the function of the key.

As indicated by the “Q”, “W”, “E”, “R”, “T”, “Y”, etc., on keys 28 (FIGS. 1 and 2), it will often be desirable that computer peripheral 26 be configured to provide conventional alphanumeric input capability. To simplify the illustration, many keys of FIGS. 1 and 2 are shown without indicia, though it will be appreciated that a label or display will often be included for each key. Furthermore, in addition to or instead of the well-known “QWERTY” formulation, the keys 28 of the keyboard may be variously configured to provide other inputs. Keys may be assigned, for example, to provide functionality for various languages and alphabets, and/or to activate other input commands for controlling computing system 20. In some implementations, the key functions may change dynamically, for example in response to the changing operational context of a piece of software running on computing system 20. For example, upon pressing of an “ALT” key, the key that otherwise is used to enter the letter “F” might instead result in activation of a “File” menu in a software application. Generally, it should be understood that the keys in the present examples may be selectively physically depressed to produce any type of input signal for controlling a computer.

Computer peripheral 26 can provide a wide variety of displayable output to enhance and otherwise augment the computing experience. In some examples, the computer peripheral causes a display of viewable output on or near the individual keys 28 to indicate key function. This can be seen in FIGS. 1 and 2, where instead of keys with letters painted or printed onto the keycap surface, a display mechanism (e.g., a liquid crystal display (LCD) device situated under the keys) is used to indicate the “Q”, “W”, etc. functions of the keys. This dynamic and programmable display capability facilitates potential use of the computer peripheral 26 in a variety of different ways. For example, the English-based keyboard described above could be alternately mapped to provide letters in alphabetical order instead of the conventional “QWERTY” formulation, and the display for each key could then be easily changed to reflect the different key assignments.

The display capability contemplated herein may be used to provide any type of viewable output to the user of computing system 20, and is not limited to alphabets, letters, numbers, symbols, etc. As an alternative to the above examples, images may be displayed in a manner that is not necessarily associated in a spatial sense with an individual key. An image might be presented, for example, in a region of the keyboard that spans multiple keys. The imagery provided need not be associated with the input functionality of the keyboard. Images might be provided, for example, for aesthetic purposes, to personalize the user experience, or to provide other types of output. Indeed, the present disclosure encompasses display output for any purpose. Also, in addition to display provided on or near keys 28, display functionality may be provided in other areas, for example in an area 32 located above keys 28. Still further, area 32 or other portions of computer peripheral 26 may be provided with touch or gesture-based interactivity in addition to the keyboard-type input provided by keys 28. For example, area 32 may be implemented as an interactive touchscreen display, via capacitance-based technology, resistive-based or other suitable methods.

Turning now to FIG. 2, computer peripheral 26 may include a display device 40 and a keyboard assembly 42 disposed over and coupled with the display device. Keyboard assembly 42 may be at least partially transparent, to allow a user to view images produced by the display device through the keyboard assembly.

A variety of types of display device 40 may be employed. As indicated briefly above, one type of suitable display device is an LCD device. Indeed, LCD devices will be frequently referred to in the examples discussed herein, though this is non-limiting and it should be appreciated that the keyboard assembly may be coupled with a variety of other display types.

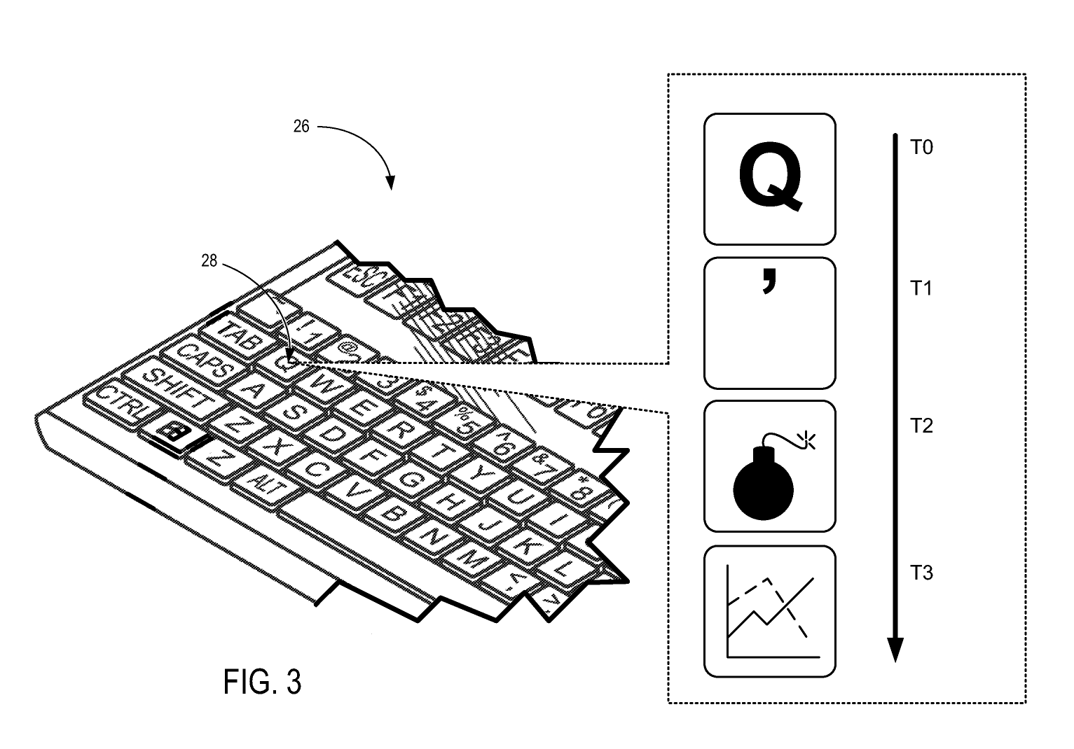

FIG. 3 provides further illustration of how the display capability of computer peripheral 26 may be employed in connection with an individual key 28. In particular, as shown respectively at times T₀, T₁, T₂, etc., the display output associated with key 28 may be changed, for example to reflect the input command produced by depressing the key. However, as previously mentioned, the viewable output provided by the computer peripheral may take forms other than displays associated with individual keys and their input functionality.

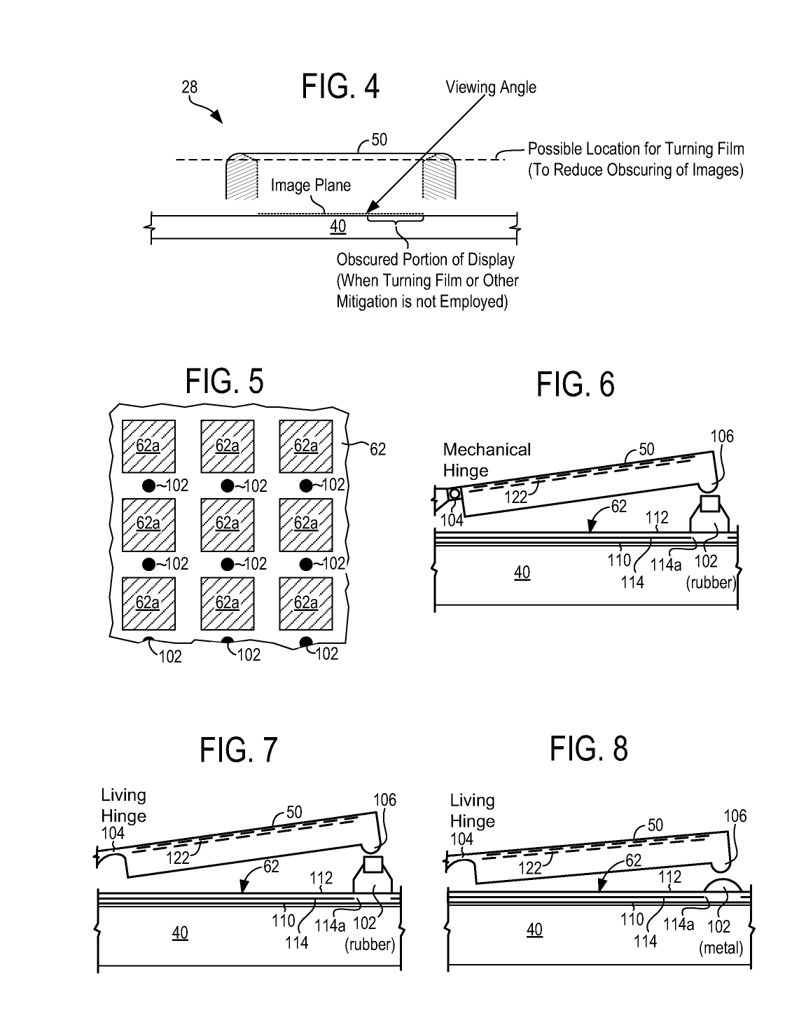

As in the examples of FIGS. 1 and 2, keyboard assembly 42 may include a plurality of keys employing some type of mechanism that enables the keys to be depressed or otherwise moved to produce an input signal. Although the term “keys” will be used primarily, this term is non-limiting, and should be understood to include buttons and any other structure or mechanism that may be moved by a user to provide input. FIGS. 4-8 show example structures that may be employed to implement individual keys of keyboard assembly 42.

As previously discussed, keyboard assembly 42 is at least partially transparent to allow images produced by display device 40 to be viewed through the keyboard. For example, the keys of the keyboard assembly may be formed using polycarbonates, acrylics or other transparent plastics to facilitate through-key viewing of images. Generally speaking, it will be desirable to minimize obscuring of display device 40 by keyboard assembly 42, and thereby maximize the area of the display device that produces viewable images for the user. This can present challenges, however, because the structures of the keyboard assembly and the positioning of the user can tend to limit the viewable area of the display.

In some cases, the construction of the keycaps of keys 28 (FIGS. 1-3) can reduce the viewable area of the underlying display. Typically, the central portion of the keycap will be transparent and allow a clear view of the underlying display. At the edges or periphery of the keycap, however, the keycap sidewalls and other structures can conceal or distort displayed images, thereby reducing the effective display area.

FIG. 4 shows an exemplary key 28, and illustrates potential effects that keycap 50 can have upon the viewable area of an underlying display, such as display device 40. In particular, the figure shows a simplified schematic of the key in its resting location (i.e., non-depressed position) over display device 40. The keycap 50 and other key structures have a thickness (e.g., between 1 and 10 millimeters), and therefore there is a potential for a “tunnel” effect through the center of each key, in which the user is looking through a rectangular tube to see the image associated with the key. This effect is most pronounced in the case of a non-projection display device, such as an LCD panel, in which the image plane is at the surface of the display device, as in the example of FIG. 4. Given an approximate viewing angle of 45 degrees, the thickness of the key results in a significant portion of the image plane being obscured by the keycap sidewall, as indicated in the figure. Further, it will be appreciated from the figure that the reduction in display area for a given viewing angle increases with increasing thickness of the key. Display reduction resulting from viewing angle may be remediated to some extent through the use of optical turning elements such as turning films and/or prisms employed in the central portion of the key.

In addition to the factors discussed above, other key structures can result in a reduction of available display area. For example, mechanical keyboards commonly employ scissor structures, post-and-plunger arrangements and other mechanisms to cause keyboard keys to move in a desired manner, such as to constrain movement to a particular direction and avoid tilting or lateral shifting of the keys. These structures are often not transparent and therefore have the potential to block or obscure a display underlying the key. Furthermore, mechanical keyboards commonly employ tactile domes or other tactile structures to provide the keyboard with a desirable feel, or action, in which a clicking or snapping occurs as keys are depressed to provide tactile user feedback. In conventional mechanical keyboards, tactile domes are commonly situated underneath the center of each key, and an associated switch is used to produce the input signal for the key. Being centered in the key, these tactile domes would also block a display situated under hollow keys.

Referring now to FIGS. 5-8, various exemplary structures will be described that may be used to implement the keyboard assembly 42 shown in FIGS. 1-3. FIG. 5 shows a base structure that may be employed with the keyboard assembly, including an offset arrangement of tactile structures that can be used to provide a desired action or feel for the keys. FIGS. 6, 7, and 8 show different key and keycap embodiments, including hinge structures that provide key movement; tactile structures that provide tactile feedback; and electrical components that produce input signals when keycaps are depressed.

Beginning specifically with FIG. 5, the keyboard assemblies include a base structure 62 to which the keys are movably coupled. Specifically, each key includes a keycap that is movably coupled relative to the base structure and that may be selectively depressed toward the base structure. As the keycap approaches the fully depressed position, the tactile structure collapses and thereby provides tactile feedback to the user. Coincident with this tactile feedback, a switch is activated to produce the input command associated with the key. The keys and keycaps are shown in FIGS. 6-8 but are not depicted in FIG. 5. As indicated in FIG. 5, base structure 62 may include a number of holes 62a. In some embodiments, keys are attached to the base structure so that the transparent keycaps are aligned over holes 62a, thereby enabling through-key viewing of images produced by display device 40 (FIGS. 2, 4 and 6-8), which is situated underneath the base structure 62.

Each keycap may be coupled to the base structure via a hinge provided at one edge of the keycap. Hinge examples will be discussed further with reference to FIGS. 6-8. Continuing first with FIG. 5, for a given one of holes 62a, a keycap may be centered over the hole and attached via a hinge at the top edge of the hole. Then, the unattached opposing edge of the keycap would be positioned over or near the bottom edge of the hole. Also, at the bottom edge of the hole, a tactile structure, such as tactile dome 102, may be provided on the base structure to interact with the opposing edge of the key when the key is depressed, to provide tactile user feedback and a desired action or feel for the key.

As an alternative to the depicted arrangement, the hinge and tactile structure for a keycap may be provided in other locations. For example, the hinge may be provided at the bottom edge of the key, with the tactile structure being provided at the top edge. Furthermore, the tactile structure and hinge may be provided at opposing side edges of the keycap, instead of at the top and bottom edges. Regardless of the particular configuration, the tactile structure may be provided at an edge of the keycap or otherwise offset from the center of the keycap. This offset position of the tactile structure will often be desirable in that it minimizes or eliminates the possibility of the tactile structure interfering with the through-key display functionality.

In relation to the “top” and “bottom” descriptions of the sides of holes 62a, it will be noted that the bottom sides of the holes are positioned nearer the user when the keyboard is being used. Thus, the bottom side or edges of the holes and keycaps may be referred to as the “front” sides or edges. Similarly, the top sides or edges may be referred to as the “back” edge/side of the hole or its associated keycap, because they are further away from the user.

Referring now to FIGS. 6-8, each figure shows a side view of an embodiment of an individual keycap 50, including a hinge 104 that movably couples the keycap with respect to the base structure 62 of the keyboard assembly. As in the previous examples, a display device 40 is disposed underneath the keyboard assembly. Keycaps 50 are at least partially transparent (e.g., in the central portion of the keycap), and in many cases the entire keycap will be made transparent to maximize the through-key display functionality.

To mitigate effective reductions in display area resulting from the user's viewing angle (e.g., as discussed with reference to FIG. 4), an optical turning element, such as turning film section 122, may be employed in connection with the keycap. It will often be desirable that the turning film be employed near the top of the key, for example near the upper surface of the keycap. Light rays from the underlying display device would then be refracted toward the user at a point near the top of the key. Because the refraction is occurring near the top of the key, the sidewall portions of the key will obscure less of the display. FIG. 4 indicates a potential location for employing a turning film. When employed, the turning film section may be co-molded with the keycap, or may be joined to the keycap via adhesive, snap-fitting, ultrasonic-welding or any other suitable joining method. In addition to or instead of a turning film, the turning element may be implemented with a turning prism. As with the turning film, the turning prism may be implemented so that the point of refraction is near the top of the key.

Opposite the hinge for each key is a tactile structure, such as tactile dome 102, which is elastically collapsed by a tab or plunger portion 106 of the key when the keycap is depressed from a rest position toward a fully depressed state. Production of the input signal occurs via interaction of a switch formed by conductive layers 110 and 112 in base structure 62, which are separated by insulating layer 114. Specifically, when the keycap is depressed to collapse the tactile dome, the conductive layers are brought into contact through hole 114a, thereby creating an electrical connection to produce the input signal. Underneath the base structure and keycap is the display device 40, which is viewable through the keycap 50 by virtue of the keycap being aligned with the holes 62a of the base structure 62 (FIG. 5). In addition to or instead of holes 62a, base structure 62 may be constructed from a transparent material to facilitate the display capability. Also, the base structure may include a rigid piece or expanse to retain and/or support the key structures, and a separate flexible portion containing the insulating and conducting layers that provide the above-described electrical switching and connectivity.

As indicated in the figures, various possibilities exist for the configuration of hinge 104. In some examples (e.g., FIGS. 7 and 8), a living hinge may be employed. In such a configuration, it may be desirable to form the keycaps and base structure as a single contiguous member, for example via a plastic injection-molding process. In other cases (e.g., FIG. 6), a separate part involving a mechanical hinge is employed. Choice of one hinge type or another may depend on desired key feel and action of the keyboard, as well as considerations relating to manufacturing, robustness and reliability. In some cases, for example, design considerations will yield a keyboard assembly where the key action is affected primarily by the tactile structure, with the hinge itself contributing little or no resistance to the key action. In such a case, a mechanical hinge may be more appropriate. On the other hand, manufacture and construction can be greatly simplified through use of a single-piece injection-molded keyboard assembly employing living hinges.

The tactile structures depicted in FIGS. 5-8 may be of varying types. For example, as in the examples of FIGS. 6 and 7, tactile domes 102 formed from a rubber-like material may be employed. In other settings, such as depicted in FIG. 8, the tactile structures may be tactile domes formed from metal. Regardless of the particular configuration or material, use of the tactile structure provides tangible, haptic feedback which affirms that the user's physical movement (i.e., pressing of the key) has in fact sent the desired input signal to the attached computer. Selection of a particular type of tactile structure may be informed by tradeoffs and considerations relating to key feel, keyboard thickness, and display performance. As described above, through-key display performance can be improved in certain embodiments by having a thinner keyboard assembly. Metal tactile domes can often be employed to reduce the keyboard assembly thickness (relative to other types of tactile structures), as will be appreciated by comparing FIG. 8 to the examples of FIGS. 6 and 7. However, in some cases a rubber-like tactile dome or other tactile structure may provide better tactile user feedback than a metal tactile dome.

The above described computer peripheral provides input capability that is enhanced with visual display functionality and tactile feedback beyond that of previous solutions which merely provide input capability without visual display functionality or provide visual input display capability without tactile feedback functionality. In particular, by providing a keyboard assembly having keys that are at least partially transparent and coupled to an underlying base structure via hinge structures, through-key viewing of images produced by a display device coupled to the underlying base structure may be facilitated. Furthermore, by providing tactile structures that are positioned away from the transparent area of the keys, tactile user feedback may be produced during key activation without impeding the display area of the keys. Accordingly, the computer peripheral may provide input capability that is enhanced with both visual display functionality and tactile feedback upon input via the keys. Moreover, the hinge structures of the keyboard assembly may be produced in a simple manner that may lower manufacturing costs of the computer peripheral.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computer peripheral, comprising:
a display device; and
a keyboard assembly disposed over the display device and configured to permit viewing of images produced by the display device through the keyboard assembly, the keyboard assembly including a base structure and a plurality of keys, wherein each of the plurality of keys:
is selectively physically depressible relative to the base structure to cause production of an input signal,
is movably coupled with respect to the base structure via a hinge at one edge of the key, and
includes a transparent portion to permit viewing of the images produced by the display device through the key.

2. The computer peripheral of claim 1, wherein for each of the plurality of keys, an entire keycap of the key is transparent to permit through-key viewing of images produced by the display device.

3. The computer peripheral of claim 1, wherein for each of the plurality of keys, the hinge which couples the key to the base structure is provided at a back edge of the key.

4. The computer peripheral of claim 1, wherein for each of the plurality of keys, the hinge which couples the key to the base structure is provided at a front edge of the key.

5. The computer peripheral of claim 1, wherein for each of the plurality of keys, the hinge which couples the key to the base structure is a living hinge.

6. The computer peripheral of claim 1, wherein for each of the plurality of keys, the hinge which couples the key to the base structure is a mechanical hinge.

7. The computer peripheral of claim 1, wherein for each of the plurality of keys, a tactile structure is provided on the base structure of the keyboard assembly to provide tactile user feedback when the key is depressed from a rest position toward the base structure.

8. The computer peripheral of claim 7, wherein the tactile structure is offset relative to a central portion of the key so as to not block through-key viewing of images produced by the display device.

9. The computer peripheral of claim 8, wherein the tactile structure is positioned at an edge of the key which is opposite the hinge.

10. The computer peripheral of claim 7, wherein the tactile structure is a tactile dome formed from metal.

11. The computer peripheral of claim 7, wherein the tactile structure is a tactile dome formed from a rubber-like material.

12. The computer peripheral of claim 1, wherein the display device is a liquid crystal display (LCD) device.

13. The computer peripheral of claim 1, further comprising, for each of the plurality of keys, an optical turning element disposed in a central portion of the key through which images produced by the display device are viewed.

14. A method of making a computer peripheral having keyboard-type input functionality and output display functionality, comprising:
providing a display device;
providing a keyboard assembly having a plurality of keys, wherein each of the plurality of keys is movably coupled to a base structure of the keyboard assembly via a hinge provided at a first edge of each of the plurality of keys;
disposing, for each of the plurality of keys, a tactile structure on the base structure of the keyboard assembly to provide tactile feedback upon depression of the key relative to the base structure; and
assembling the keyboard assembly to the display device so that the keyboard assembly is disposed over the display device to permit viewing of images produced by the display device through the plurality of keys, each of the plurality of keys having a central transparent portion to permit said viewing of the images.

15. A computer peripheral, comprising:
a display device; and
a keyboard assembly disposed over the display device and configured to permit viewing of images produced by the display device through the keyboard assembly, the keyboard assembly including a base structure and a plurality of keys, wherein each of the plurality of keys:
includes a central transparent portion to permit viewing of the images produced by the display device through the key,
is selectively physically depressible relative to the base structure to cause production of an input signal,
is movably coupled with respect to the base structure via a hinge at one edge of the key, and
is disposed so that an opposing edge of the key interacts, upon depression of the key, with a tactile structure that is disposed on the base structure of the keyboard assembly in a location that is offset from the central transparent portion of the key.

16. The computer peripheral of claim 15, wherein the display device is a liquid crystal display (LCD) device.

17. The computer peripheral of claim 15, wherein the tactile structure structure is a tactile dome formed from metal.

18. The computer peripheral of claim 15, wherein the tactile structure is a tactile dome formed from a rubber-like material.

19. The computer peripheral of claim 15, wherein the hinge is a living hinge.

20. The computer peripheral of claim 15, wherein the hinge is a mechanical hinge.
